(19) United States
(12) Patent Application Publication
(10) Pub. No.: US 2007/0140579 A1
(43) Pub. Date: Jun. 21, 2007

(54) Image signal processing apparatus, method of image signal processing, and image signal processing system

(75) Inventor: Satoshi Miyashita, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/519,742

(22) Filed: Sep. 12, 2006

(30) Foreign Application Priority Data
Sep. 13, 2005 (JP) P2005-265565

(51) Int. Cl. G06K 9/40; H04N 9/73

(52) U.S. Cl. 382/254; 348/224.1

(57) ABSTRACT

An image signal processing apparatus includes an image pickup unit operable to take image information; an image signal-processing unit operable to process the image information; a display unit operable to display the image information on a display; a recording unit operable to record the image information onto a recording medium; a reproducing unit operable to reproduce the recorded image information; a communication unit operable to communicate with an external image display to display the image information on the external image display; an obtaining unit operable to obtain an adjustive image pattern used to adjust image quality so as to correspond to image-displaying performance of the external image display; an adjustive image display unit which permits the adjustment of the image quality by correcting parameters used by the image signal-processing unit to perform image signal processing based on the adjustive image pattern, the adjustive image display unit acting to display the adjustive image pattern representing an uncorrected state and a corrected state on the external image display; and a correcting unit operable to correct the image quality to match displaying characteristics of the external image display by correcting the parameters used by the image signal-processing unit to perform the image signal processing so as to correspond to the corrected adjustive image pattern displayed by the adjustive image display unit.

### CROSS-REFERENCE TO RELATED APPLICATIONS

The present application claims priority from Japanese Patent Application No. JP2005-265565 filed on Sep. 13, 2005, the disclosure of which is hereby incorporated by reference herein.

### BACKGROUND OF THE INVENTION

1. Field of the Invention

The present invention relates to image signal processing apparatus, method of image signal processing, and image signal processing system that can be applied to a camera-integrated recording/reproducing device or the like that can be connected, for example, with a television monitor.

2. Description of the Related Art

From the past, image recording/reproducing devices, image processors, and methods of image processing have been known which use a digital camera capable of being connected with an external image display such as a television monitor, obtain information about the displaying performance of the external image display such as the size of the display screen, aspect ratio, γ-characteristics, resolution, hue, corresponding image format, and so on from the memory in the external image display or from a server on the Internet by communication, set parameters used in image processing based on the information, correct the image quality to quality adapted for the display device, output a camera signal, and perform recording and reproduction (see, for example, JP-A-2004-320614 and JP-A-2003-259207 (patent references 1 and 2)).

Also, an external image display capable of correcting deviation of white balance due to aging variations by the body of the external image display has been known (JP-A-2001-8226(patent reference 3)).

It is customary to accept images taken by a digital camera or camera-integrated recording/reproducing device into a personal computer such that the image quality is modified in a favorable way.

The digital cameras described in patent references 1 and 2 can display images optimally in some standard audiovisual environments. However, even environments under which users actually listen to and view such as the brightness of the audiovisual surroundings and the distance to the connected external image display have not been taken into consideration. Therefore, it may not be said that in cases where the elements of the audiovisual environments are different, display is provided at image quality favorable to the user in practice. Accordingly, there has been the inconvenience that the display image quality of the picked up image has deteriorated.

The external image display described in patent reference 3 simply corrects deviation of the white balance due to aging variations by the body of the external image display. It may not be possible for a digital camera or camera-integrated recording/reproducing device to correct the quality of an image taken by the digital camera or camera-integrated recording/reproducing device to quality matched to the external image display connected with the digital camera or camera-integrated recording/reproducing device.

Where an image taken by an imaging device such as a digital camera or camera-integrated recording/reproducing device is accepted into a personal computer and the image quality is modified in a favorable way, processing for accepting the image once into the personal computer and processing for making a correction on the side of the personal computer while identifying a portion of the accepted image to be modified are typically required. That is, much labor may be required. In addition, it may not be possible to automatically correct the image quality to quality adapted for the external image display.

Additionally, with a digital camera or camera-integrated recording/reproducing device, if only an image signal outputted from the image sensor of the camera portion is recorded, it may be substantially impossible to cope with various shooting conditions. Therefore, digital cameras and camera-integrated recording/reproducing devices generally have a function of performing processing for making variable the white balance, exposure level, gain control, and frequency characteristics regarding the image signal.

Where a digital camera or camera-integrated recording/reproducing device is directly connected with an external image display and an image is displayed, it is appropriate to output or record an image after performing nonlinear displaying processing such as correction of gamma characteristics to cope with the displaying characteristics of the external image display.

Therefore, where processing for correcting the image quality is performed in the external image display or where processing for correcting the image quality is performed during the work for correcting the image accepted in the personal computer, a substantially double image processing is done on the image signal outputted from the image sensor if image processing in the camera portion on a finite number of quantization bits performed during shooting is included. There is the possibility that the quantization noise increases and the S/N deteriorates, i.e., the image quality deteriorates.

### SUMMARY OF THE INVENTION

In view of these circumstances, it is desirable to provide an image signal processing apparatus, a method of image signal processing, and an image signal processing system which make it unnecessary for an external image display to make any correction by introducing audiovisual environment, information about the external image display, aging variations, and user's taste into settings of image processing by the user using a simple method, storing these kinds of information into a memory, and permitting correction of the image quality during shooting.

An image signal processing apparatus according to one embodiment of the present invention includes image pickup means for taking image information; image signal-processing means for processing the image information; display means for displaying the image information on a display; recording means for recording the image information onto a recording medium; reproducing means for reproducing the recorded image information; communication means for communicating with an external image display to display the image information on the external image display; obtaining means for obtaining an adjustive image pattern used to adjust image quality so as to correspond to image-displaying performance of the external image display; adjustive image display means which permits the adjustment of the image quality by correcting parameters used by the image signal-processing means to perform image signal processing based on the adjustive image pattern, the adjustive image display means acting to display the adjustive image pattern representing two states (i.e., an uncorrected state and a corrected state) on the external image display; and correcting means for correcting the image quality to match displaying characteristics of the external image display by correcting the parameters used by the image signal-processing means to perform the image signal processing so as to correspond to the corrected adjustive image pattern displayed by the adjustive image display means.

A method of image signal processing according to another embodiment of the present invention includes communicating with an external image display to display image information having undergone image signal processing on the external image display; obtaining an adjustive image pattern used to adjust image quality such that the image quality corresponds to image-displaying performance of the external image display; permitting the adjustment of the image quality by correcting parameters used to perform the image signal processing based on the adjustive image pattern and displaying the adjustive image pattern representing two states (i.e., an uncorrected state and a corrected state) on the external image display; and correcting the image quality to match the displaying characteristics of the external image display by correcting the parameters used to perform the image signal processing so as to correspond to the displayed, corrected adjustive image pattern.

An image signal processing system according to a further embodiment of the present invention has an image signal processing apparatus and an external image display. The image signal processing apparatus includes image pickup means for taking image information; image signal-processing means for processing the image information; display means for displaying the image information on a display; recording means for recording the image information onto a recording medium; reproducing means for reproducing the recorded image information; communication means for communicating with the external image display to display the image information on the external image display; obtaining means for obtaining an adjustive image pattern used to adjust image quality so as to correspond to image-displaying performance of the external image display; adjustive image display means which permits the adjustment of the image quality by correcting parameters used by the image signal-processing means to perform image signal processing based on the adjustive image pattern, the adjustive image display means acting to display the adjustive image pattern representing two states (i.e., an uncorrected state and a corrected state) on the external image display; and correcting means for correcting the image quality to match displaying characteristics of the external image display by correcting the parameters used by the image signal-processing means to perform the image signal processing so as to correspond to the corrected adjustive image pattern displayed by the adjustive image display means. The external image display includes storage means for storing information including information about settings of adjustment of the image quality of the external image display and information about various characteristics possessed by the external image display.

According to the above-described image signal processing apparatus, method of image signal processing, and image signal processing system according to embodiments of the present invention, the image quality is adjusted according to the external image display such as a TV receiver, display device, monitor unit, or projector. Therefore, the adjustive image pattern for image quality adjustment is produced from the camera portion to match the information about the displaying performance of the external image display and is obtained by the obtaining means. The adjustive image pattern obtained by the obtaining means is subjected to image signal processing in the camera signal-processing portion of the camera portion. Then, the pattern is outputted to the external image display and an image of the pattern is displayed by the adjustive image display device. This adjustive image pattern may be read in from a detachable recording medium.

The user can easily perform an operation for adjusting the image quality using the adjustive image pattern displayed on the external image display while taking account of the ambient audiovisual environment, aging variations of the displaying capabilities of the external image display, the taste of the user, and other elements. Corresponding corrective processing can be performed by the correcting device on the camera signal-processing portion of the camera portion. Parameters used in processing the image signal obtained as a result of the adjustment can be stored in the storage means of the camera portion and utilized during shooting. When an image shot and recorded is viewed on the external image display to which the output is delivered after the adjustment, neither image quality correction on the side of the external image display nor image quality correction of the image accepted into the personal computer may be necessary.

According to embodiments of the present invention, in the image signal processing apparatus, the method of image signal processing, and the image signal processing system that can be applied to a camera-integrated recording/reproducing device or the like capable of being connected with the external image display such as a TV monitor, the user can match them to the surrounding audiovisual environment using the adjustive image pattern displayed on the external image display to cope with fixing of audiovisual environment caused by increase in size of the display screen of the external image display. Furthermore, the operation for adjusting the image quality can be easily carried out while taking account of the aging variations of the displaying capabilities of the external image display and the user's taste. Consequently, corresponding corrective processing can be performed on the camera portion side.

At this time, the parameters used in processing the image signal can be corrected based on information about adjustment of the image quality when the camera portion takes photos, by storing the information about the adjustment of the image quality in the inside of the camera portion. In consequence, deterioration of quantization noise due to corrective processing performed on the external image display side or due to correction of the image quality of the image accepted in the personal computer can be prevented. Furthermore, extra labor can be circumvented. Additionally, there arises the advantage that the image quality can be directly corrected in conformity with the audiovisual environment and the user's taste and that the display image quality of the shot image can be improved.

### BRIEF DESCRIPTION OF THE DRAWINGS

FIG. 1 is a diagram of a system configuration showing an embodiment of the present invention.

FIG. 2 is a block diagram showing an example of a camera signal-processing portion.

FIG. 3 is a view showing the manner in which image information for white balance adjustment is accepted into an image recording/reproducing device.

FIG. 4 is a view showing an image displayed on a display screen for performing white balance.

FIG. 5 is a view showing an example of an image displayed on a display screen used for white balance adjustment.

FIG. 6 is a view showing an example of OSD for manual white balance adjustment.

FIG. 7 is a view showing an example of an image displayed on a display screen for manual adjustments of hue and chroma.

FIG. 8 is a view showing an example of an OSD for adjustments of hue and chroma.

FIG. 9 is a view showing an example of an image displayed on a display screen for adjustment of frequency characteristics.

FIG. 10 is a view showing an example of an OSD for adjustment of frequency characteristics.

FIG. 11 is a view showing an example of an image displayed on a display screen for gray scale adjustment.

FIG. 12 is a view showing an example of an OSD for gray scale adjustment.

FIG. 13 is a view showing an example of an image displayed on a display screen for brightness adjustment.

FIG. 14 is a view showing an example of an OSD for brightness adjustment.

FIGS. 15A and 15B show an example of communication about a DDC (Display Data Channel) of a communication device for obtaining information about image quality settings, in which FIG. 15A indicates data and FIG. 15B indicates a clock signal.

FIG. 16 is a table showing an example of information about image quality settings stored in a display device information EEPROM.

### DETAILED DESCRIPTION

Embodiments of the present invention are hereinafter described by appropriately referring to the drawings.

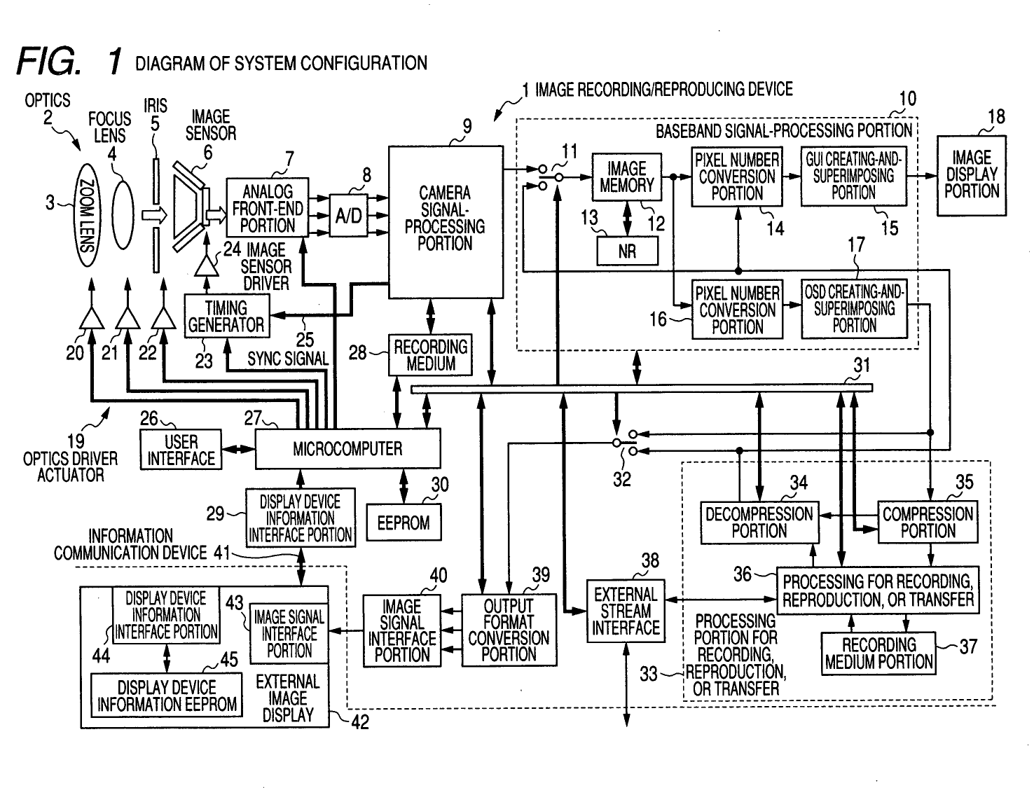

FIG. 1 is a diagram showing the system configuration of an embodiment of the present invention.

In FIG. 1, an image recording/reproducing device 1 has optics 2 including a zoom lens 3, a focus lens 4, and an iris 5, an optics driver actuator 19 (20, 21, 22) for driving the zoom lens 3, the focus lens 4, and the iris 5, an image sensor 6, and a timing generator 23 cooperating with a driver 24 to drive the image sensor 6.

The image recording/reproducing device 1 has an analog front-end portion 7, an A/D converter portion 8, and a camera signal-processing portion 9. The analog front-end portion 7 processes the output signal from the image sensor 6 in various manners (e.g., sample holding, black level clamping, and gain control). The camera signal-processing portion 9 processes the digital signal images taken by the image sensor 6 for recording, transmitting, and displaying the images in such a way that the brightness of the images, color balance, frequency characteristics, gray level characteristics, hue, chroma, number of pixels, and so on can be adjusted and converted.

The camera signal-processing portion 9 has an input portion capable of processing a reproduction signal from a recording medium (described later) and an image signal from external streams as well as the signal from the image sensor 6.

FIG. 2 shows an example of configuration in block diagram form of the camera signal-processing portion 9.

In FIG. 2, the camera signal-processing portion 9 has a recording medium interface portion 52 for entering 3 primary color signals (R, G, B) from the recording medium 28, an adjustive image pattern-generating portion 53 for generating an adjustive image pattern, a black clamping portion 55 for clamping the black level of the 3 primary color signals (R, G, B) that are given by input of a signal 54 from the image sensor 6, and switches 56, 57, and 58 for switching the connection of the recording medium interface portion 52 between the output from the adjustive image pattern-generating portion 53 and the output from the black clamping portion 55.

The camera signal-processing portion 9 has a gain control portion 59 for performing processing for gain control about the 3 primary color signals (R, G, B), a white balancing portion 60 for performing white balance of the gain controlled 3 primary color signals (R, G, B), a gamma conversion (1/γ) portion 61 for performing gamma conversion (1/γ) of the white balanced 3 primary color signals (R, G, B), a brightness conversion matrix portion 62 for converting the brightness of the gamma-converted (1/γ) 3 primary color signals (R, G, B) and outputting a brightness signal, and a low-pass filter (LPF) 63 for passing low-frequency components of the brightness signal obtained by the conversion.

The camera signal-processing portion 9 has an RF component-extracting filter 64 for extracting the RF component of the white-balanced 3 primary color signals (R, G, B) and outputting a brightness signal, a gain control portion 65 for performing processing for gain control of the brightness signal after extraction of the RF components, and an adder portion 66 acting to sum up the gain-controlled brightness signal and the brightness signal obtained by passing the low-frequency components and to output a brightness signal (Y).

The camera signal-processing portion 9 has a detection portion 69 for detecting the brightness of the light source and color temperature relative to the reference level from the gain-controlled 3 primary color signals (R, G, B) and the white-balanced 3 primary color signals (R, G, B), a low-pass filter (LPF) 70 for passing low-frequency components of the gamma-converted (1/γ) 3 primary color signals (R, G, B), and a hue/gain matrix portion 71 for combining the hue and gain of the 3 primary color signals (R, G, B) obtained after filtering of the low-frequency components and for outputting color-difference signals (R−Y and B−Y).

Thus, the camera signal-processing portion 9 outputs the brightness signal (Y) outputted from the adder portion 66 and the color difference signals (R−Y and B−Y) as an image signal output 72, the color-difference signals being outputted from the hue/gain matrix portion 71.

The camera signal-processing portion 9 is also equipped with a microcomputer interface portion 68 for exchanging a control signal and data with a microcomputer 158 via a control bus 67. The microcomputer interface portion 68 is connected with all of the black clamping portion 55, gain control portion 59, white balancing portion 60, gamma conversion (1/γ) portion 61, brightness conversion matrix portion 62, low-pass filter (LPF) 63, RF component-extracting filter 64, gain control portion 65, detection portion 69, low-pass filter (LPF) 70, and hue/gain matrix portion 71.

Referring back to FIG. 1, the image recording/reproducing device 1 has a baseband signal-processing portion 10 including a switch 11 for selecting the image signal from the camera signal-processing portion 9, the reproduction signal from the recording medium 37, or the input image signal from an external stream interface 38, an image memory 12 for holding these image signals, a noise reduction portion 13 for removing noise from the image signal held in the image memory 12, pixel number conversion portions 14, 16 for converting, if necessary, the number of pixels of the image signal from the camera signal-processing portion 9, reproduction signal from the recording medium 37, and the input image signal from the external stream interface 38 and displaying these signals on an image display portion 18 such as an LCD (liquid crystal display) panel and on an external image display 42, and a GUI creating-and-superimposing portion 15 and OSD creating-and-superimposing portion 17 for superimposing a GUI (graphical user interface) and an OSD (on screen display) on the output from the image display portion 18 such as the LCD panel and on the output for the external image display 42, respectively, and outputting the resultant signals according to instructions from the microcomputer 27.

The image recording/reproducing device 1 also includes an image display portion 18 such as an LCD panel for displaying an image signal from the camera which has undergone baseband signal processing, reproduction signal from the recording medium, input image from the external stream, and GUI. This image display portion 18 is mounted on the body of the image recording/reproducing device. The camera portion is constituted by the various portions described so far.

The image recording/reproducing device 1 also has an encoded amount decompression portion 34 and compression portion 35 for compressing and decompressing the output signal from the camera signal-processing portion 9 such that the signal is recorded on the recording medium or the signal recorded on the medium is reproduced or for compressing or decompressing an image signal in a stream applied from the outside or an image signal within a stream outputted to the outside, a processing portion 33 for recording, reproduction, or transfer to perform error correction such that any signal assumes a format suitable for recording or reproduction on or from the recording medium 37 or the signal is converted into a format suitable for stream transmission, a built-in or detachable recording medium portion 37, and a detachable recording medium 28.

The image recording/reproducing device 1 further includes the external stream interface portion 38 for performing processing of input and output of streams, an output format conversion portion 39 for converting the output signal from the camera signal-processing portion 9 or decompressed image data into an image format adapted for the external image display 42 or converting the signal into a color space as the need arises, and an image signal interface portion 40 for transmitting the image signal to the external image display 42.

The image recording/reproducing device 1 further includes a user interface 26 for performing input operations for control of various portions in response to user's manipulations, a display device information interface portion 29 for gaining information about the displaying performance of the external image display 42 by communications, a communication device 41 that is an interface with the network server, an EEPROM (electrically erasable read only memory) 30 that is a nonvolatile memory for storing parameters used by the microcomputer 27 to control various portions, information data about the external image display obtained by communications, and information about audiovisual environments obtained by user's manipulations, and a microcomputer 27 for automatically or fixedly controlling the various portions described so far based on information about manipulations from the user interface 26.

The external image display 42 has a display device information EEPROM 45 that is a nonvolatile memory for internally storing image quality setting information according to the display performance such as the size of the screen of the display device itself, aspect ratio, y-characteristics, resolution, hue, and corresponding image format. The display device 42 further includes a display device information interface portion 44 for sending the information stored in the EEPROM to the image recording/reproducing device 1 through the information communication device 41 and an image signal interface portion 43 for receiving an image signal from the image recording/reproducing device 1.

Preferably, the display device information data in the display device information EEPROM 45 within the external image display 42 is pursuant to EDID (Extended Display Identification Data) of a VESA (Video Electronics Standards Association) standard.

Individual-identifying information (image quality setting information) data contained in the EDID is sent by a HDMI (High Definition Multimedia Interface) via the information communication device 41. The image signal interface portion 43 which displays the image signal from the image and audio recording/reproducing device 1 and makes reception for outputting of an audio signal performs the operations via a TMDS (Transition Minimized Differential Signaling) channel. The display device information interface portion 44 that sends individual-identifying information (image quality setting information) data to the image and audio recording/reproducing device 1 performs the reception via the DDC (Display Data Channel).

FIGS. 15A and 15B are diagrams showing an example of communication regarding the DDC (Display Data Channel) of the communication device for obtaining image quality setting information. FIG. 15A indicates data. FIG. 15B indicates a clock signal. For example, if communication is started (131) at instant T1, the image and audio recording/reproducing device 1 specifies an address (132) in the display device information EEPROM 45 within the external image display 42. At instant T2, a control signal 133 for reading and/or writing (R/W) is sent from the image and audio recording/reproducing device 1 to the external image display 42.

If the external image display 42 sends back an acknowledgement (ACK) 134 indicating reception of the control signal 133 of reading and/or writing (R/W) to the image and audio recording/reproducing device 1 at instant T3, the external image display 42 sends data 135 about the image quality setting information in the display device information EEPROM 45 specified by the address designation 132 at instant T4 to the image and audio recording/reproducing device 1.

If the image and audio recording/reproducing device 1 sends back an acknowledgement (ACK) 136 indicating reception of the data 135 about the image quality setting information to the external image display 42 at instant T5, communication end 137 occurs at instant T6.

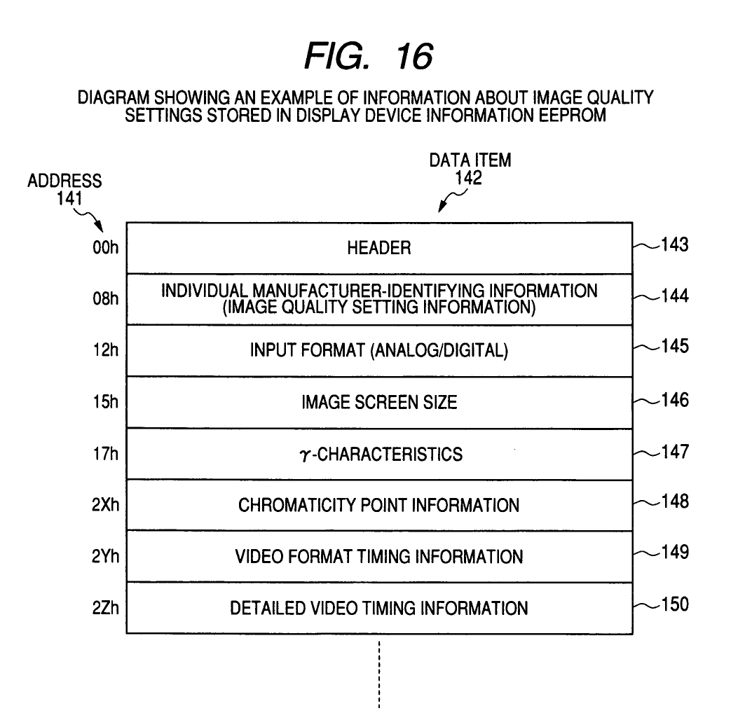

FIG. 16 is a view showing an example of image quality setting information stored in the display device information EEPROM.

For example, a header 143 is stored as a data item 142 at address 141 of 00h (in hexadecimal notation). Individual manufacturer-identifying information (image quality setting information) 144 is stored as a data item 142 at address 141 of 08h. Essential image quality setting information may be stored in a corresponding manner to the individual-identifying information. Furthermore, arbitrary image quality setting information may be stored for each image quality setting item as given below.

For example, an input format (analog or digital) 145 is stored as the data item 142 at address 141 of 12h. An image screen size 146 is stored as the data item 142 at address 141 of 15h.

Furthermore, γ-characteristics 147 are stored as the data item 142 at address 141 of 17h. Chromaticity point information 148 is stored as the data item 142 at address 141 of 2Xh.

Video format timing information 149 is stored as the data item 142 at address 141 of 2Yh. Detail video timing information 150 is stored as the data item 142 at address 141 of 2Zh.

Specific examples of image quality adjustment items include (1) white balance (color temperature correction), (2) hue and chroma, (3) frequency characteristics, (4) gray scale characteristics, and (5) brightness.

With respect to these items, the user makes adjustments using the OSD for image quality adjustment (described later) while watching the adjustive image pattern displayed on the external image display 42. The microcomputer 27 of the image and audio recording/reproducing device 1 corrects the image-processing parameters of the camera signal-processing portion 9 so as to correspond to the adjusted value. Thus, image quality correction is accomplished.

The image and audio recording/reproducing device 1 of the present embodiment has the following four points as first features of the device.

First, as shown in FIG. 2, the adjustive image pattern can be produced from the adjustive image pattern generation portion 53 within the camera signal-processing portion 9 or read in from the detachable recording medium 28 via the recording medium interface 52. Furthermore, the adjustive image pattern can also be entered from the signal input 54 of the image sensor. After selecting these adjustive image patterns using the switches 56, 57, and 58, an image pattern is entered by switching the signal input 54 of the image sensor, and image processing is performed. The results of the image processing are stored in the image memory 12 and can be outputted to the external image display 42. In addition, manipulations can be performed for image quality adjustment or image quality correction while monitoring the image pattern derived as a result of the processing on the external image display 42 that is the output destination.

If it is difficult to create a very complex image because of the level of processing load or the cost incurred for that purpose, the image pattern created from the adjustive image pattern generation portion 53 may be restricted to a pattern that can be created relatively simply based on the synchronization signal from a synchronous signal generation portion 51. If within a tolerance range, one having capabilities of storing data about images actually photographed and outputting the data may also be used.

Where the adjustive image pattern created by the adjustive image pattern generation portion 53 is judged to be outputted with difficulty or where one wants to make adjustments by adding a new adjustive image pattern, updating the pattern, and using the updated image pattern, an image pattern may be read in from the detachable recording medium 28, image processing may be performed, then the resultant image may be outputted to the external image display 42, and an adjustment may be made using the outputted image.

Secondly, if one wants to adjust the image quality while taking account of the effects of the compression involved in recording or reproduction of an adjustive image pattern on the image quality, the result of the compression performed by the compression portion 35 may be subjected directly to decompression of the decompression portion 34 without via the recording medium 37, the resulting image pattern may be stored in the image memory 12, and the image pattern may be outputted to the external image display 42.

Thirdly, the image pattern displayed on the external image display 42 during adjustment can be displayed in an intuitively understandable form for the user by two relatively comparable forms corresponding to two states derived before and after correction, respectively.

Fourthly, image-processing parameters derived as a result of an adjustment can be stored in the EERPOM 30. The stored parameters can be used as image quality corrective information during shooting or recording.

Operation for correcting the image quality in conformity with audiovisual environment of the image recording/reproducing device 1 constructed in this way is hereinafter described.

A method of processing for correcting the image quality in conformity with the audiovisual environment includes the following processing.

First, an adjustive image pattern is outputted to the external image display 42, where the pattern is displayed. At this time, image quality setting information is accepted into the image recording/reproducing device 1 from the external image display 42 and stored in the EEPROM 30.

Then, manipulations are performed to adjust the image quality based on the image pattern displayed on the external image display 42. Correspondingly, processing for correcting the image quality is performed. At this time, values about the image quality adjustment and image quality correction are stored as signal processing parameters in the EEPROM 30.

Information about the image quality adjustment of the image pattern and the image quality correction is added and used as camera signal processing parameters in the camera signal-processing portion 9 during shooting, recording, and reproduction. The image quality is corrected to match the audiovisual environment.

The above-described various steps of the processing are next described in detail.

First, processing for outputting an adjustive image pattern to the external image display 42 such that the pattern is displayed on the device is described.

The user connects the present image recording/reproducing device 1 with the external image display 42 through the image signal interface 40. The image signal from the image recording/reproducing device 1 is displayed on the external image display 42.

Where the external image display 42 is equipped with a function of correcting the image quality, this correcting function is deactivated, and the external image display 42 is placed in its default setting condition.

The user now selects an adjustive image pattern for each individual item to be corrected via the user interface 26.

A first example of the adjustive image pattern is totally white state used for white balance adjustment.

The color temperature is matched with the value of the external image display 42 to obtain white color on a black body radiator corresponding to the color temperature. At this time, the user may obtain the color temperature setting on the external image display 42 as image quality setting information and establish the color temperature of the output image. Alternatively, the color temperature setting on the external image display 42 may be obtained and established as image quality setting information via a communication device such as a DDC. The totally white state is not 100% pure white but is brightish white at an intermediate level.

This adjustive image pattern generation portion 53 may produce only one kind of white color. The white balancing portion 60 at the rear stage may correct the color temperature according to the color temperature of the external image display 42 and output the corrected color temperature.

A second example of an adjustive image pattern is a color image for adjustment of hue and/or chroma. The color image includes R, G, B, Ye (yellow), Cy (cyan), and Mg (magenta). Each color signal has an intermediate level within the dynamic range of the signal. This image may be, for example, a general SMPTE (Society of Motion Picture and Television Engineering) color bar as shown in FIG. 7.

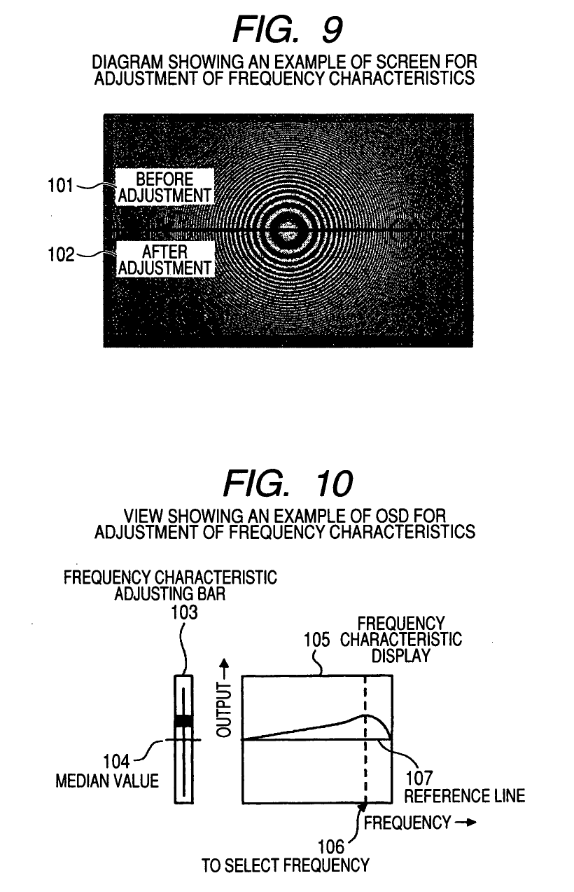

A third example of an adjustive image pattern is an image used for adjustment of the frequency characteristics including the DC components and various components from a low frequency to a maximum frequency in the two-dimensional image outputted from the camera portion. This image may be, for example, an ITE (Institute of Television Engineering) circular zone plate as shown in FIG. 9. The ITE circular zone plate is made of radiating lines. In a natural image, geometrical edges such as of tree leaves, fibrous meshes, human hairs, and buildings are contained in a distant view.

A fourth example of an adjustive image pattern is an image for brightness adjustment. The image includes from black having a level higher than complete black level to white having a level lower than the upper limit of the signal level within the dynamic range of the image signal. For instance, the image may be a gray scale as shown in FIG. 13. However, it may also be a ramp waveform as described later.

The image for brightness adjustment is used to reproduce the state in which a black subject is really seen to be brighter and floating when the camera is shooting or in which a subject of white color of high brightness is seen to be sunk darkly.

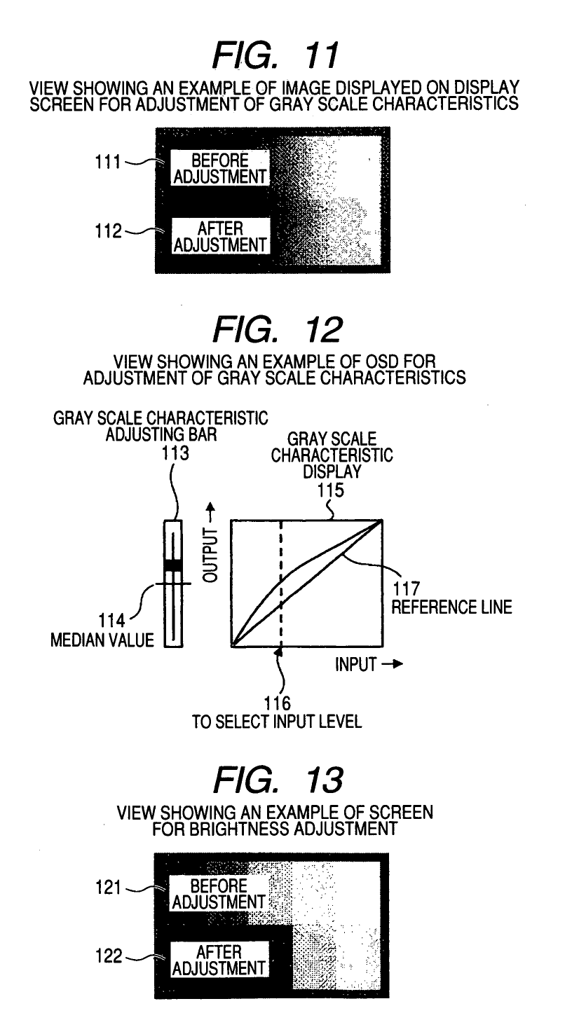

A fifth example of an adjustive image pattern is a ramp waveform for gray scale adjustment as shown in FIG. 11. This image is an image of a metal having a curved surface such as a spoon and has a smoothly varying gray level.

Furthermore, an adjustment may be made with a single image containing all of these elements for adjustment.

Although the adjustive image pattern can be entered into the external image display 42 from the adjustive image pattern generation portion 53 within the image recording/reproducing device 1, any arbitrary adjustive image pattern may be recorded on the detachable recording medium 28.

Where the user wants to make an adjustment using an image taken by the camera portion of the image recording/reproducing device 1, the black level of the image signal from the image sensor 6 is clamped by the black clamping portion 55 of the camera signal-processing portion 9. Image data obtained after the black clamping is recorded on the recording medium 28. Data about the shooting conditions including the color temperature detected by the detection portion 69 and the brightness level for automatic exposure are also recorded on the recording medium 28. When this adjustive image pattern is recorded, the camera portion may be placed in its default condition to set image processing and shooting conditions.

When an adjustment is made, the microcomputer 27 reads in the image data and data about the shooting conditions. The gain control portion 65 provides gain control. The white balancing portion 60 performs white balance. The resulting data are outputted to the external image display 42, where the adjustment is made.

Manipulations for adjusting the image quality based on the displayed adjustive image pattern and concomitant processing for correcting the image quality are next described.

The user selects items to be adjusted using switches on the image display portion 18 and the user interface 26 displayed on the LCD panel, and makes adjustments. An example of the processing is described below.

If the user selects the adjustive image pattern, the image signal from a signal source passes through various processing portions of the camera signal-processing portion 9 and is outputted to the baseband signal-processing portion 10.

The baseband signal-processing portion 10 stores the image signal in the image memory 12 and outputs the signal to the external image display 42.

Adjustment of white balance is first described.

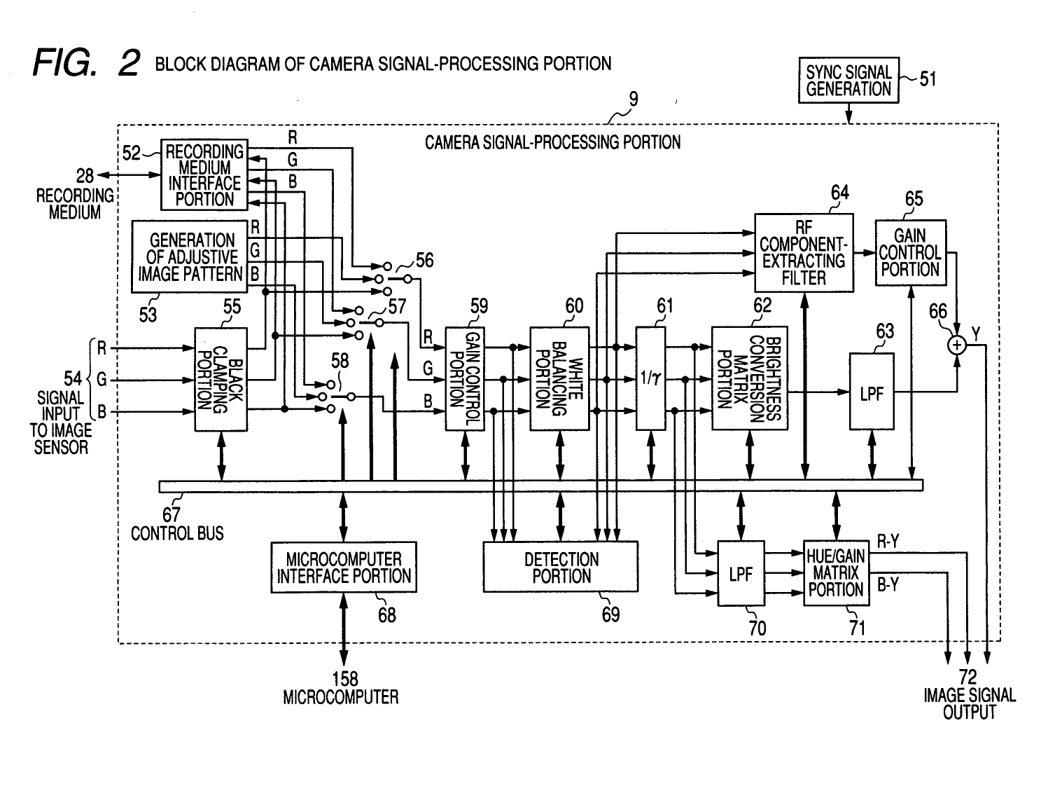

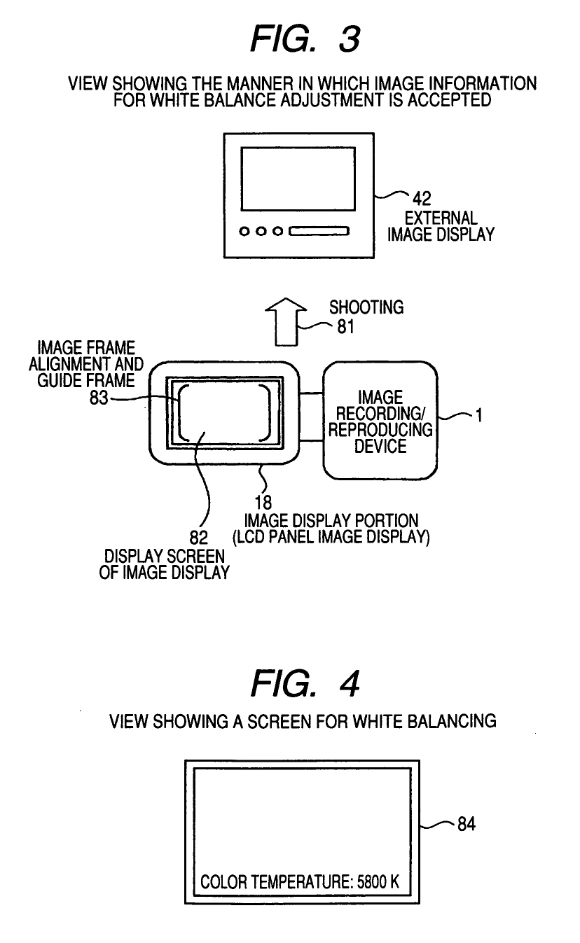

After a white image 84 for achieving white balance as shown in FIG. 4 is displayed on the external image display 42, the display screen of the external image display 42 is imaged by the present image recording/reproducing device 1 as indicated by 81 in FIG. 3. At this time, a frame 83 acting as a guide for frame alignment is displayed on the LCD panel of an image display portion 18 ancillary to the body of the recording/reproducing device 1. The user aligns the image frame such that the display screen of the external image display 42 lies over the LCD panel of the image display portion 18 and that the inside of the image frame alignment and guide frame 83 is filled with white color for display. The detection portion 69 of the camera signal-processing portion 9 detects a region corresponding to the inside of the image frame alignment and guide frame 83.

Based on the detection value obtained by the detection portion 69 of the camera signal-processing portion 9, an operation for pulling white color onto a black body radiator is performed by the auto white balancing function of the white balancing portion 60. A white balance correction value obtained after the pulling is stored into the EEPROM 30 by the microcomputer 27. If the color temperature of the original white created by the adjustive image pattern generation portion 53 is coincident with the color temperature of the external image display 42, no correction should be necessary when the white balancing portion 60 achieves white balance. However, there is a possibility that deviation might be produced due to aging variations of the external image display 42. The resulting difference is reflected as a correcting value.

After the end of the operation described so far, the baseband signal-processing portion 10 stores the white output from the camera signal-processing portion 9 pulled in by the auto white balancing function into the image memory 12.

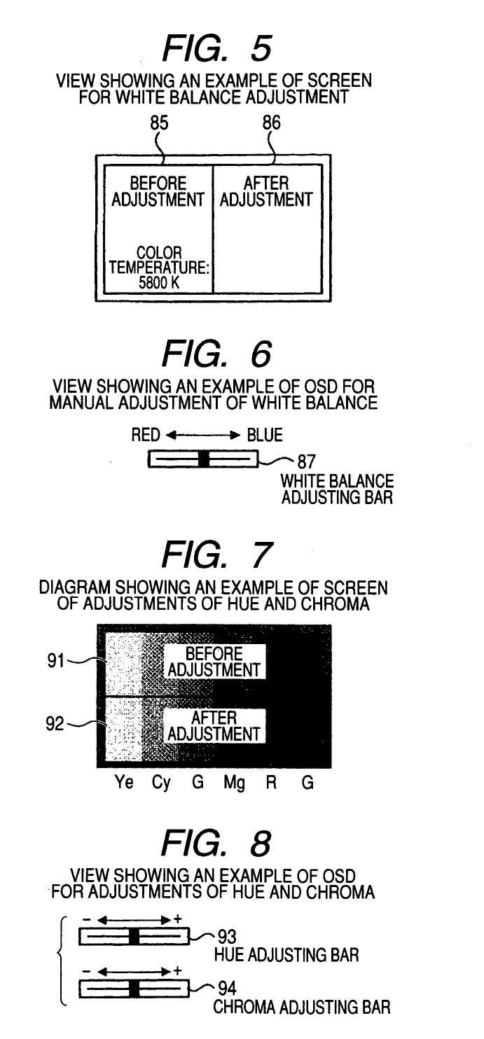

Then, as shown in an example of display of FIG. 5, unadjusted white color 85 previously stored in the image memory 12 and adjusted white color 86 pulled in by the white balancing function are displayed in a side by side relation within the single display screen on the external image display 42.

A white balance adjusting bar 87 is shown as an example of the user interface OSD in FIG. 6. The user can check the status of the white balance before and after an adjustment by adjusting the white balance adjusting bar 87 toward the red side or blue side. The white balance adjusting bar 87 can be adjusted using the up/down keys or right/left keys on the user interface 26.

If the adjustment is made unsatisfactorily, the user can make a correction by making a further adjustment with the white balance adjusting bar 87 of the user interface OSD.

The camera signal-processing portion 9 outputs the corrected white image to the baseband signal-processing portion 10 according to user's instructions. The baseband signal-processing portion 10 stores the image in the image memory 12, replaces it by the immediately previously adjusted white image 86, and outputs the image to the external image display 42.

Because of this operation, the user can check the results of the adjustment made by his or her preference by relative comparison with the original white color.

In practice, these steps of processing can be performed at high speed and so the user is prevented from being subjected to stress due to the time differences of processing.

The correcting value for the white balance finally obtained by the operation described so far is stored into the EEPROM 30 by the microcomputer 27.

Secondly, adjustments of hue and chroma are described in detail.

The microcomputer 27 stores adjustive image patterns for adjustments of hue and chroma into the image memory 12 of the baseband signal-processing portion 10 and outputs the patterns to the external image display 42.

At this time, as shown in an example of display of FIG. 7, the display screen is split into a display portion for an unadjusted state (before adjustment 91) and a display portion for an adjusted state (after adjustment 92). For each of the colors R, G, B, Ye (yellow), Cy (cyan), and Mg (magenta), an unadjusted image and adjusted image of the same color can be compared.

A hue adjusting bar 93 and a chroma adjusting bar 94 are shown in FIG. 8 as examples of the user interface OSD. The hue adjusting bar 93 and chroma adjusting bar 94 can be adjusted with the up/down keys and left/right keys on the user interface 26.

Hue and chroma are adjusted by the user who manipulates the hue adjusting bar 93 and chroma adjusting bar 94 to give instructions. In practice, the image is corrected by the hue/gain matrix portion 71 of the camera signal-processing portion 9 under control of the microcomputer 27 in a corresponding manner to instructions given by manipulations of the hue adjusting bar 93 and chroma adjusting bar 94.

At the stage when the user has determined adjusting values, the microcomputer 27 stores settings of the adjusting values into the EEPROM 30.

Thirdly, adjustment of the frequency characteristics is described in detail.

The microcomputer 27 stores an adjustive image pattern for the frequency characteristics into the image memory 12 of the baseband signal-processing portion 10 and outputs the pattern to the external image display 42.

At this time, as shown in an example of display of FIG. 9, the display screen is split into a display portion for an unadjusted state (before adjustment 101) and a display portion for an adjusted state (after adjustment 102), and these are outputted from the image memory 12.

A frequency characteristic adjusting bar 103 and a frequency characteristic display 105 are shown as examples of user interface OSD in FIG. 10. The frequency characteristic adjusting bar 103 and frequency characteristic display 105 can be adjusted with the up/down keys and left/right keys of the user interface 26.

The frequency characteristic display 105 being an example of OSD provides a display like graphical equalizer of frequency against output. Display can be provided vertically, horizontally, and obliquely from a low-frequency portion in the center of the display screen to a high-frequency portion at an end thereof in the example of display of FIG. 9, by selecting a frequency indicated by 106 from a reference line 107 corresponding to a median value 104.

The frequency characteristics are adjusted according to instructions given by user's manipulations of the frequency characteristic adjusting bar 103 and frequency characteristic display 105. Actual processing of the image is done by frequency selection of RF component-extracting filter 64 of the camera signal-processing portion 9 and gain control under control of the microcomputer 27 in a corresponding manner to instructions given by manipulations of the frequency characteristic adjusting bar 103 and frequency characteristic display 105.

The RF component-extracting filter 64 performs extraction at plural frequency ranges in each of vertical, horizontal, and oblique 45° directions from a low-frequency portion in the center of the display screen to an RF portion at an end thereof, of the example of display of FIG. 9. With respect to each of the extracted RF components, gain control is provided in an interlocking manner with instructions given by user's manipulations of the frequency characteristic adjusting bar 103 and frequency characteristic display 105.

The user adjusts the value to his favorite value while watching the state of the contour of the images obtained before adjustment 101 and after adjustment 102 of the image displayed on the display screen of FIG. 9 showing an example of display.

At the stage when the user determines the adjusting value, the setting of the adjusting value is stored into the EEPROM 30 by the microcomputer 27.

Fourthly, adjustment of the brightness is described in detail.

The microcomputer 27 stores the image pattern for adjustment of brightness into the image memory 12 of the baseband signal-processing portion 10 and outputs the pattern to the external image display 42.

At this time, as shown in the example of display of FIG. 13, the image displayed on the display screen is split into left and right portions corresponding to unadjusted state (prior to adjustment 121) and adjusted state (after adjustment 122). The resulting data are outputted from the image memory 12.

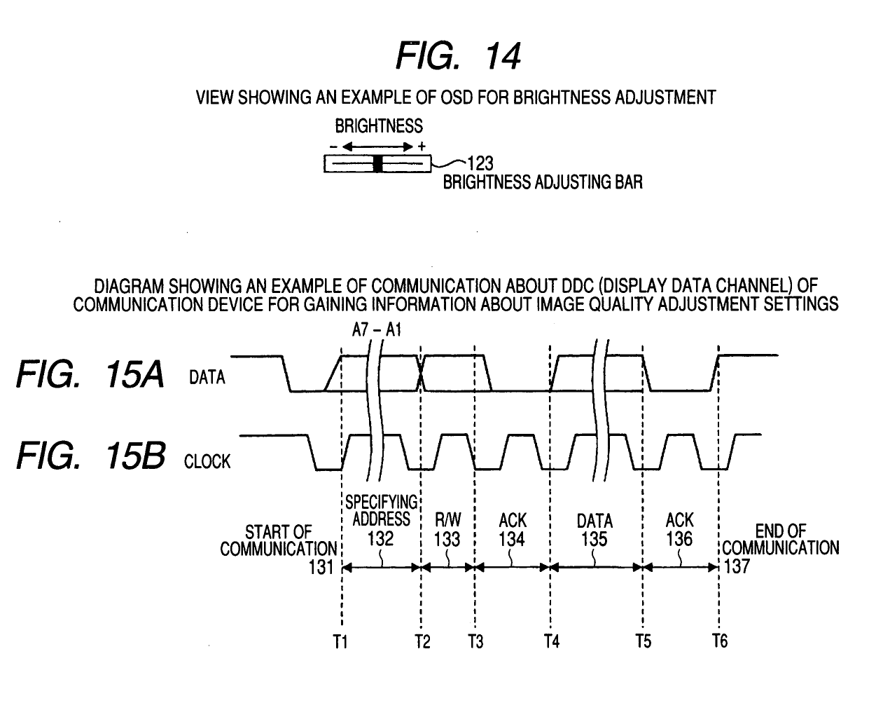

A brightness adjusting bar 123 is shown in FIG. 14 as an example of user interface OSD. The brightness adjusting bar 123 can be adjusted with the up/down keys and left/right keys of the user interface 26.

The brightness is adjusted according to user's instructions indicated by manipulations of the brightness adjusting bar 123. Actual image processing is done by the gain control portion 65 of the camera signal-processing portion 9 under control of the microcomputer 27 in a corresponding manner to instructions given by manipulations of the adjusting bar 123.

At the stage when the user determines the adjusting value, the microcomputer 27 stores the setting of the adjusting value into the EEPROM 30.

An example in which an adjustment is made only by the gain control portion 65 is shown herein. When this corrective data is used in practice, the corrective data is used in such a way that the reference brightness is corrected over the whole operation of automatic exposure. The corrective data is also applied to control of the iris 5 to open and close it and to the operation of an electronic shutter for the image sensor 6.

Fifthly, adjustment of the gray scale is described in detail.

The microcomputer 27 stores the image pattern for adjustment of the gray scale into the image memory 12 of the baseband signal-processing portion 10 and outputs the pattern to the external image display 42.

At this time, as shown in the example of display of FIG. 11, the image displayed on the display screen is split into left and right portions corresponding to unadjusted state (before adjustment 111) and adjusted state (after adjustment 112). The resulting data are outputted from the image memory 12.

A gray scale adjusting bar 113 and a gray scale characteristic display 115 are shown in FIG. 12 as examples of user interface OSD. The gray scale characteristic adjusting bar 113 and gray scale characteristic display 115 can be adjusted with the up/down keys and left/right keys of the user interface 26.

The gray scale characteristics are adjusted according to instructions given by user's manipulations of the gray scale adjusting bar 113 and gray scale characteristic display 115. Actual image processing is done by correcting the gamma-curve (γ-curve) associated with the input-output relationship of the gamma conversion (1/γ) portion 61 of the camera signal-processing portion 9 under control of the microcomputer 27 in a corresponding manner to instructions given by manipulations of the gray scale adjusting bar 113 and gray scale characteristic display 115.

The user adjusts the value to his favorite adjusting value while watching the status of the contrast of the image obtained before adjustment 111 and after adjustment 112 on the display screen showing an example of display of FIG. 11.

At the stage when the user determines the adjusting value, the microcomputer 27 stores the setting of the adjusting value into the EEPROM 30.

The γ-curve of the adjusting value obtained at this time is used for gamma conversion at the gamma conversion (1/γ) portion 61 during actual shooting.

While items for adjusting the image quality using the adjustive image pattern have been described so far, the image quality may be adjusted using any arbitrary image as described below. The adjustive image pattern is not limited to a fixed adjustive image pattern.

Sixthly, adjustment of the image quality using an image photographed by the user is described.

The microcomputer 27 enters the image recorded on the recording medium 28 into the camera signal-processing portion 9. The microcomputer 27 gains the data about the shooting conditions corresponding to the image. The microcomputer 27 sets parameters corresponding to various portions of the camera signal-processing portion 9 based on the data about the shooting conditions. The image taken during the shooting is reproduced by the signal processing at various portions of the camera signal-processing portion 9 based on the parameters.

The microcomputer 27 stores the reproduced image taken during shooting into the image memory 12 of the baseband signal-processing portion 10 and outputs the image to the external image display 42.

The user determines the settings of favorite adjusting values by adjusting the first through fifth items of adjustment of the image quality using the aforementioned adjustive image pattern while watching the reproduced image taken during shooting, the reproduced image being displayed on the display screen of the external image display 42.

At the stage when the adjusting values are determined, the microcomputer 28 stores parameters corresponding to the adjusting values into the EEPROM 30.

When the image quality is adjusted using the items of adjustment of the image quality employing the adjustive image pattern or when the image quality is adjusted using an arbitrary image, the effects of compression and decompression of image are not taken into consideration. The image quality may also be adjusted taking account of the effects of compression and decompression of image as described below.

Seventhly, adjustment of the image quality taking account of the effects of compression and decompression is described.

Where the microcomputer 27 outputs the image having undergone the signal processing by the camera signal-processing portion 9 directly to the external image display 42, the image quality is adjusted using the first through fifth image quality-adjusting items employing the adjustive image pattern and using an arbitrary image pattern, thus coping with the situation.

Where one wants to check the image quality while taking account of compression of encoded amount involved in recording an image on a recording medium 37, the microcomputer 27 performs compression and decompression by means of the decompression portion 34 and compression portion 35. Then, the image compressed and decompressed can be recorded in the image memory 12 of the baseband signal-processing portion 10 and outputted to the external image display 42.

For example, in compression of encoded amount using DCT (discrete cosine transformation) such as JPEG (Joint Photographic Experts Group) or MPEG (Moving Pictures Experts Group), there is the possibility that the image suffers from deterioration of frequency characteristics. It is possible to make an adjustment while checking the image including such elements.

Processing for outputting the aforementioned adjustive image pattern to the external image display 42 and displaying the pattern is next described. Also, processing is described in which shooting, recording, and reproduction are performed while making use of corrective information about manipulations for adjusting the image quality based on the displayed adjustive image pattern as well as corrective information made of information about the setting values used during concomitant processing for correcting the image quality.

The various portions of the camera signal-processing portion 9 correct the parameters used during signal processing in various parts of the camera signal-processing portion 9 during shooting using the camera portion under control of the microcomputer 27 while taking account of the data about adjustment stored in the EEPROM 30 up to the manipulations for adjusting the image quality based on the displayed adjustive image pattern and concomitant processing for image quality correction. Image processing is performed. Thus, the image quality is corrected.

First, correction of the white balance is described.

When the white balancing portion 60 operates to perform white balance relative to the color temperature of the light source detected by the detection portion 69, the white balancing portion 60 corrects the balance between R, G, and B that are parameters of the white balance based on the adjustment data under control of the microcomputer 27.

Secondly, correction of hue and chroma is described.

In processing for converting the R, G, and B signals into color difference signals of R−Y and B−Y in the hue/gain matrix portion 71, the matrix portion 71 performs a calculation given by Eq. (1) below under control of the microcomputer 27, thus correcting the coefficients of Rgain, RHue, Bgain, and BHue that are parameters of the hue/gain matrix based on the adjustment data.

$$\{ \begin{matrix}R - Y = R gain * ( R - G ) + B Hue * ( B - G ) \\ B - Y = B gain * ( B - G ) + R Hue * ( R - G )\end{matrix} \qquad ( 1 )$$

Thirdly, correction of the frequency characteristics is described.

The RF component-extracting filter portion 64 corrects the gain for each frequency component that is a parameter in extracting RF components based on the adjustment data under control of the microcomputer 27.

Fourthly, correction of the brightness is described.

The reference level for automatic exposure is corrected based on the adjustment data under control of the microcomputer 27.

In actual operation, the reference level for automatic exposure is corrected and the brightness is determined according to (i) a control value for opening and closing of the iris 5, (ii) a control value for the speed of the electronic shutter 6, and (iii) the value of the gain of the gain control portion 65, the values being parameters.

Fifthly, correction of the gray scale is described.

The gamma conversion (1/γ) portion 61 corrects the γ-curve that is a parameter in performing a gamma conversion based on the adjustment data under control of the microcomputer 27.

Obviously, the invention is not limited to the above-described embodiments. The configurations of the embodiments of the present invention described above can be modified appropriately within the scope delineated by the appended claims.

1. An image signal processing apparatus, comprising:
image pickup means for taking image information;
image signal-processing means for processing the image information;
display means for displaying the image information on a display;
recording means for recording the image information onto a recording medium;
reproducing means for reproducing the recorded image information;
communication means for communicating with an external image display to display the image information on the external image display;
obtaining means for obtaining an adjustive image pattern used to adjust image quality so as to correspond to image-displaying performance of the external image display;
adjustive image display means which permits the adjustment of the image quality by correcting parameters used by the image signal-processing means to perform image signal processing based on the adjustive image pattern, the adjustive image display means acting to display the adjustive image pattern representing an uncorrected state and a corrected state on the external image display; and
correcting means for correcting the image quality to match displaying characteristics of the external image display by correcting the parameters used by the image signal-processing means to perform the image signal processing so as to correspond to the corrected adjustive image pattern displayed by the adjustive image display means.

2. The image signal processing apparatus of claim 1, wherein the adjustive image pattern permits selection of any one of: obtaining the image pattern by shooting a display screen of the external image display using the image pickup means, obtaining the image pattern from a signal generator within the image signal processing means, and obtaining the image pattern from a detachable other recording medium.

3. The image signal processing apparatus of claim 1, wherein the adjustive image pattern is adjusted to match information including information about settings of adjustment of the image quality of the external image display obtained from the external image display and information about various characteristics possessed by the external image display.

4. The image signal processing apparatus of claim 1, wherein the adjustive image pattern is different among each individual item of image quality adjustment.

5. The image signal processing apparatus of claim 1, further comprising storage means for storing information about adjustment of the image quality of the adjustive image pattern after correction made by the adjustive image display means and information about the correction of the image quality made by correcting the parameters in performing image signal processing in the image signal-processing means by means of the correcting means.

6. The image signal processing apparatus of claim 5, wherein
the parameters are corrected using the information stored in the storage means as corrective information in image signal processing performed by the image signal processing means, and
image information is imaged by the image pickup means, the image information is recorded by the recording means, and/or the image information is reproduced by the reproducing means.

7. A method for performing image signal processing on image information for a taken image, displaying the image information, recording the image information on a recording medium, and reproducing the recorded image information, the method comprising:
accepting image information having undergone the image signal processing;
communicating with an external image display to display the image information on the external image display;
obtaining an adjustive image pattern used to adjust image quality so as to correspond to image-displaying performance of the external image display;
permitting the adjustment of the image quality by correcting parameters used to perform the image signal processing based on the adjustive image pattern;
displaying the adjustive image pattern representing an uncorrected state and a corrected state on the external image display; and
correcting the image quality to match the displaying characteristics of the external image display by correcting the parameters used to perform the image signal processing so as to correspond to the displayed, corrected adjustive image pattern.

8. An image signal processing system, comprising:
an image signal processing apparatus; and
an external image display connected to the image signal processing apparatus and acting to display information for an image having undergone image signal processing;
the image signal processing apparatus including
image pickup means for taking image information;
image signal-processing means for processing the image information;
display means for displaying the image information on a display;
recording means for recording the image information onto a recording medium;
reproducing means for reproducing the recorded image information;
communication means for communicating with the external image display to display the image information on the external image display;
obtaining means for obtaining an adjustive image pattern used to adjust image quality so as to correspond to image-displaying performance of the external image display;
adjustive image display means which permits the adjustment of the image quality by correcting parameters used by the image signal-processing means to perform image signal processing based on the adjustive image pattern, the adjustive image display means acting to display the adjustive image pattern representing an uncorrected state and a corrected state on the external image display; and
correcting means for correcting the image quality to match displaying characteristics of the external image display by correcting the parameters used by the image signal-processing means to perform the image signal processing so as to correspond to the corrected adjustive image pattern displayed by the adjustive image display means; and
the external image display includes storage means for storing information including information about settings of adjustment of the image quality of the external image display and information about various characteristics possessed by the external image display.

9. An image signal processing apparatus, comprising:
an image pickup unit operable to take image information;
an image signal-processing unit operable to process the image information;
a display unit operable to display the image information on a display;
a recording unit operable to record the image information onto a recording medium;
a reproducing unit operable to reproduce the recorded image information;
a communication unit operable to communicate with an external image display to display the image information on the external image display;
an obtaining unit operable to obtain an adjustive image pattern used to adjust image quality so as to correspond to image-displaying performance of the external image display;
an adjustive image display unit which permits the adjustment of the image quality by correcting parameters used by the image signal-processing unit to perform image signal processing based on the adjustive image pattern, the adjustive image display unit acting to display the adjustive image pattern representing an uncorrected state and a corrected state on the external image display; and
a correcting unit operable to correct the image quality to match displaying characteristics of the external image display by correcting the parameters used by the image signal-processing unit to perform the image signal processing so as to correspond to the corrected adjustive image pattern displayed by the adjustive image display unit.
